(19) United States
(12) Patent Application Publication
(10) Pub. No.: US 2016/0268673 A1
(43) Pub. Date: Sep. 15, 2016

(54) ADJUSTABLE ANTENNA AND ANTENNA MOUNTING

(71) Applicant: BBY SOLUTIONS, INC., Richfield, MN (US)

(72) Inventors: Mahmood Majid, Lakeville, MN (US); Nancy Gezella, Maple Grove, MN (US); Brian Dunfee, Apple Valley, MN (US); Edson Takei, Apple Valley, MN (US)

(73) Assignee: BBY SOLUTIONS, INC., R ichfield, MN (US)

(21) Appl. No.: 14/657,377

(22) Filed: Mar. 13, 2015

(51) Int. Cl. H01Q 1/24; H04N 5/64

(52) U.S. Cl. CPC H01Q 1/24; H04N 5/64

(57) ABSTRACT

Generally discussed herein are antennas and antenna mounts. For example, an antenna mount configured to mount to a flat panel television may include: a post that receives a connector (such as a screw) to mount the post in a mounting hole located in a back panel of the television, a brace that attaches to a connection feature of the post, and a platform that provides a surface on which to receive an antenna. The brace may provide a length sufficient to allow the platform to be positioned above a top edge of the television as the antenna mount is mounted to the television. In further examples, the shapes, sizes, placements, and orientations of the connections between the antenna mount and the television conform to Video Electronics Standards Association (VESA) specifications, such as for mounting to designated VESA mounting holes on the hack panel of the television.

### TECHNICAL FIELD

Examples described herein generally relate to television antennas and antenna mounts. Some specific examples described herein relate to antennas and antenna mounts coupled to a flat screen television.

### BACKGROUND

An external antenna is often used for receiving analog or digital television signals. Antennas can be configured in a variety of shapes and sizes. The size and/or shape of the antenna can determine which frequencies the antenna can reliably receive. For example, some antennas are configured as quarter wave length antennas in which a length of a conductive portion of the antenna is about one quarter of the wavelength of the signal to be received or transmitted.

Classic, box style televisions provided a natural space for a television antenna to reside—on the top of the television. As televisions have evolved to be thinner, the natural space for the television antenna to reside has been diminished to the point where many antennas cannot stand securely on the top of the television. Also, some television owners do not like the aesthetics of a television antenna on the top of their television and would prefer a television antenna to be located out of sight.

### BRIEF DESCRIPTION OF THE DRAWINGS

FIG. 1 illustrates a perspective view diagram of an antenna mounted on a back panel of a television according to an example.

FIG. 2 illustrates a perspective view diagram of back panel of a television.

FIG. 3A illustrates a perspective view diagram of an antenna mount attached to a television back panel according to an example.

FIG. 3B illustrates a perspective view diagram of an antenna mount attached to a television back panel according to another example.

FIG. 3C illustrates a perspective view diagram of an antenna mount attached to a television stand according to an example.

FIG. 3D illustrates a perspective view diagram of an antenna mount attached to a television back panel according to another example.

FIG. 3E illustrates a perspective view diagram of an antenna mount attached to a television back panel and including a cable guide according to yet another example.

FIG. 3F illustrates a perspective view diagram of a cable channel for an antenna mount according to an example.

FIG. 3G illustrates a perspective view diagram of a cable channel cover for an antenna mount according to an example.

FIG. 4A illustrates a perspective view diagram of the antenna mount of FIG. 3A as viewed from the arrows labelled “4A” according to an example.

FIG. 4B illustrates a perspective view diagram of the antenna mount of FIG. 3D as viewed from the arrows labelled “4B” according to an example.

FIG. 4C illustrates a perspective view diagram of the antenna mount of FIG. 3B as viewed from the arrows labelled “4C/4E” according to an example.

FIG. 4D illustrates a perspective view diagram of another antenna mount according to an example.

FIG. 4E illustrates a perspective view diagram of the antenna mount of FIG. 3B as viewed from the arrows labelled “4C/4E” according to an example.

FIGS. 5A, 5B, 5C, and 5D illustrate perspective view diagrams of respective platforms as viewed from the arrows labelled “5A-B” and “5C-D” according to an example.

FIG. 6A illustrates a perspective view diagram of a post configured for mounting to a back panel of a television according to an example.

FIG. 6B illustrates a perspective view diagram of a bracket configured to mount on the post of FIG. 6A according to an example.

FIG. 6C illustrates a perspective view diagram of a post configured for mounting to a back panel of a television according to an example.

FIGS. 6D and 6E illustrate perspective view diagrams of respective brackets configured to mount on the post of FIG. 6C according to an example.

FIG. 6F illustrates a perspective view diagram of a bracket as viewed from the arrows labelled “6F” according to an example.

FIG. 6G illustrates a perspective view diagram of a post (e.g., a spacer) configured for mounting to a back panel of a television according to an example.

FIG. 7A illustrates a perspective view diagram of a telescoping bracket according to an example.

FIG. 7B illustrates a perspective view diagram of a bracket configured for mounting on a platform according to an example.

FIG. 7C illustrates a perspective view diagram of another bracket configured for mounting on a platform according to an example.

FIG. 7D illustrates a perspective view diagram of another bracket configured for mounting on a platform according to an example.

FIG. 8A illustrates a perspective view diagram of an antenna mount attached to a wall mount bracket on a back panel of a television according to an example.

FIG. 8B illustrates a side view diagram of the antenna mount, wall mount bracket, and television of FIG. 8A according to an example.

FIG. 9A illustrates a perspective view diagram of another antenna mount attached to a wall mount bracket on a back panel of a television according to an example.

FIG. 9B illustrates a side view diagram of the antenna mount, wall mount bracket, and television of FIG. 9A according to an example.

FIG. 10A illustrates a perspective view diagram of another antenna mount attached to a wall mount bracket on a back panel of a television according to an example.

FIG. 10B illustrates a side view diagram of the antenna mount, wall mount bracket, and television of FIG. 10A according to an example.

FIG. 11 illustrates a perspective view diagram of a wall mount bracket attached to a television mount on a back panel of a television according to an example.

### DETAILED DESCRIPTION

The following description and the drawings sufficiently illustrate specific examples to enable those skilled in the art to practice them. Other examples may incorporate structural, logical, electrical, process, and other changes. Portions and features of some examples may be included in, or substituted for, those of other examples. Examples set forth in the claims encompass all available equivalents of those claims.

Reference numbers with different letter suffixes refer to instances of the same item while reference numbers without suffixes refer to the item generally. For example a reference number “314” refers to a bracket generally and the reference numbers “314A” and “314B” refer to a specific instance of the bracket 314.

Some of the examples described herein describe improved systems and apparatuses of an antenna or an antenna mount. In one or more examples, a television antenna mount can provide a mechanism to attach a television antenna to a television (e.g., a flat screen or flat panel LCD or Plasma television). One or more of the antennas and mounts discussed herein can provide more efficient antenna attachment mechanisms by attaching an antenna mount on a television back panel (e.g., the panel opposite the viewing screen), such as by situating the antenna closer to an antenna input port on the television, thus shortening the length of cable needed to connect the antenna to the television. A shorter cable can help increase the signal gain as compared with a longer cable. One or more of the antennas or mounts discussed herein can provide a mechanism to hide the antenna and/or the antenna cable behind the television, such as to help improve the aesthetics of the television area.

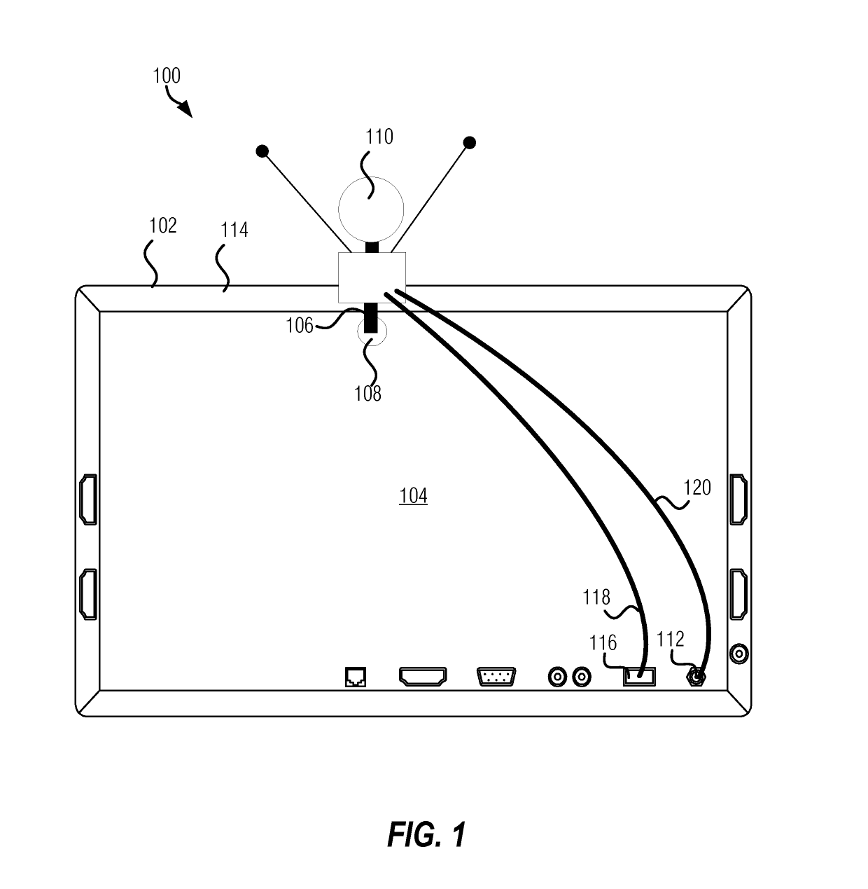

FIG. 1 illustrates a perspective view diagram of a device configuration 100 including an antenna 110 mounted on a back panel 104 of a television 102 according to an example. The back panel 104 of the television 102 is the side of the television 102 opposite the screen.

The antenna 110 can include an ultra-high frequency (UHF), very high frequency (VHF) or passive or active radio frequency (RF) antenna. An active antenna can be powered by an external power source, such as a power adapter or a USB port 116 of a television, such as through a cable 118. The antenna 110 can be electrically and mechanically connected to a television data port, such as a coaxial connection port, through the cable 120.

The antenna 110, as illustrated, is mounted to a female or male connection feature 108 in the back panel 104. The connection feature 108 may be threaded or unthreaded. The connection feature 108 is situated on a surface (e.g., the back panel 104) that is substantially parallel to the screen of the television. The antenna 110 can be mechanically coupled to the attachment mechanism 106 that attaches the antenna 110 directly to the back panel 104. The attachment mechanism 106 can include a threaded screw, machine screw, bolt, fastener, or other connector configured to mate with the connection feature 108 in an example in which the connection feature 108 is threaded. In one or more examples, the attachment mechanism 106 can include a male or female connection feature configured to mate with a corresponding female or male connection feature 108.

The connection feature 108 can be situated on/in the back panel 104 in a location that allows the antenna 110 to extend beyond a top surface 114 of the television 102. Such a configuration can allow the antenna 110 to have a line of sight without being impeded by the television, thus helping maintain the reception of the antenna 110.

The antenna 110 can be connected to the television 102 at the antenna input port 112. The antenna input port 112 can include a coax (e.g., an F-type) connector or other antenna connector.

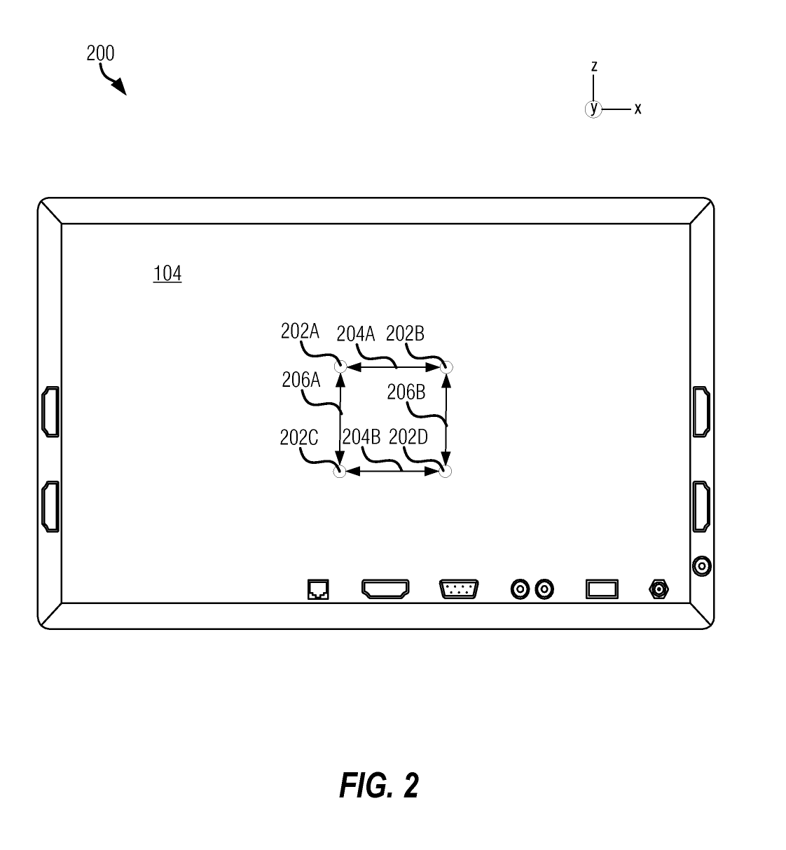

FIG. 2 illustrates a perspective view diagram of a back panel 104 of a television 200 according to an example. The back panel 104 can include a plurality of mounting holes 202A, 202B, 202C, and 202D therein. For purposes of this example, the mounting holes 202A-D are compliant with a Video Electronics Standards Association (VESA) standard, such as can be compatible with an M4, M6, or M8 machine screw of a variety of lengths. The mounting holes 202A-D can be configured to allow the television to be mounted to a television stand, wall, or other structure, such as an antenna mount.

The horizontal distance between mounting holes 202A-B and 202C-D (indicated by the arrows 204A and 204B, respectively) can be the same or different distances. The vertical distance between mounting holes 202A and 202C and 202B and 202D (indicated by the arrows 206A and 206B, respectively) can be the same or different distances. The horizontal distances can be the same or different distances as the vertical distances. In examples that conform to the VESA standard for center mounts on the back panel of the television the horizontal distance (x-direction) between mounting holes 202A-D (on center) is 20 mm, 35 mm, 75 mm, or 100 mm while the vertical distance (z-direction) between mounting holes 202A-D is 50 mm, 75 mm, 75 mm, and 100 mm or 200 mm, respectively. The depth of the mounting holes may or may not conform to the VESA standard.

One or more of the antenna mounts discussed herein can be configured to conform to a specific configuration of mounting holes 202A-D (e.g., a specific horizontal distance and/or vertical distance between mount holes, such as those specified in the VESA standard) 202A-D or can be configured to accommodate a range of configurations of mounting holes 202A-D, such as to provide a universal antenna mount that can be attached to a variety of television back panels that include a variety of mounting hole configurations.

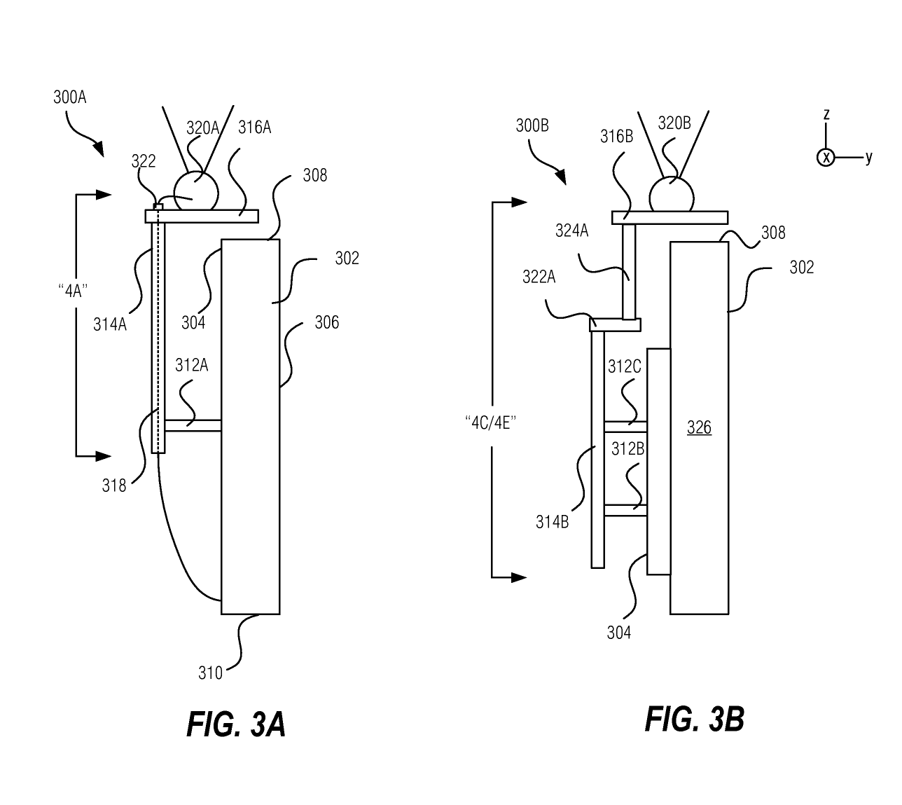

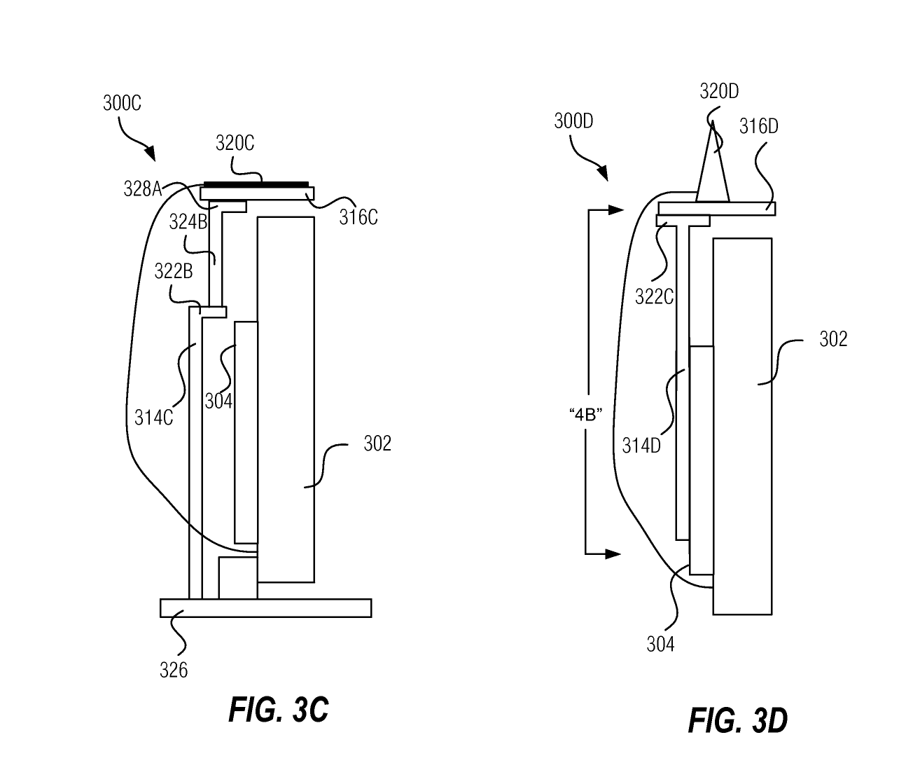

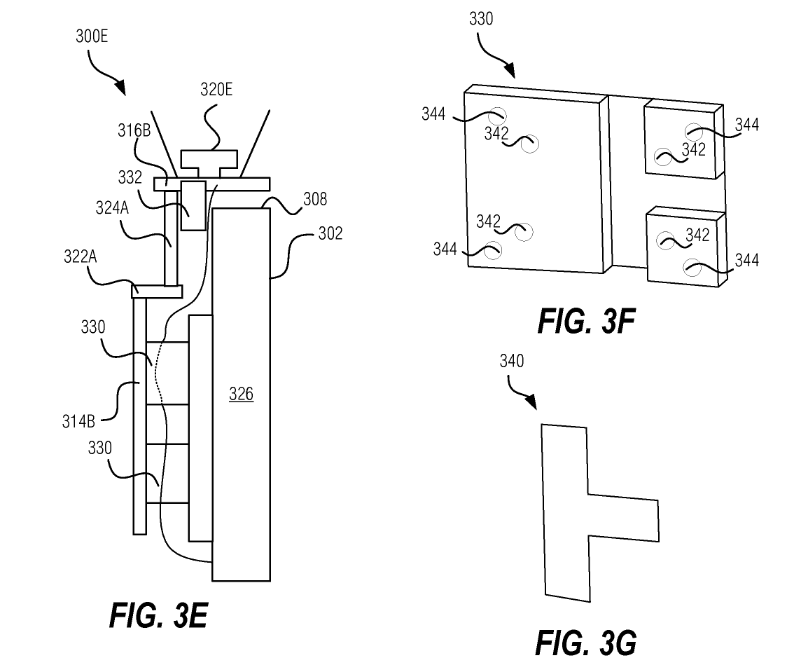

FIG. 3A illustrates a perspective view diagram of an antenna mount system 300A according to an example. The system 300A includes an antenna mount attached to a back panel 304 of a television 302. The antenna mount can include the post 312A, the bracket 314A, and the platform 316A.

The television 302 as illustrated includes a back panel 304 opposite a front panel 306 (e.g., a screen) and a top surface 308 (e.g., a top edge) opposite a bottom surface 310 (e.g., a bottom edge). The back panel 304 can include one or more mounting holes (see FIG. 2) that are threaded. An antenna mount can be secured to the television 302 through the mounting holes.

The antenna mount as illustrated includes the post 312A (e.g., a spacer), one or more brackets 314A, and a platform 316A. The post 312A can be attached to the mounting holes of the back panel 304, such as by bolts, screws, or like connectors. The bracket 314A can be attached to the posts 312A, such as by screws, nuts, a slotted hole, a combination thereof, or other attachment mechanism. In one or more examples, the platform 316A can be attached to the bracket 314A, such as by screws, nuts, a combination thereof, or other attachment mechanism. In one or more other examples, the platform 316A can be integrally formed with the bracket 314A.

The bracket 314A can include an electrically conductive material running therethrough (indicated by the dotted line 318). The electrically conductive material can include a coated or uncoated wire or cable, among others. The conductive material can be connected to the television 302, such as at an antenna input of the television.

An antenna 320A can be situated on the platform 316A. In one or more examples, the antenna can be clipped, snapped, or otherwise secured to the platform, such as by securing the antenna 320A to a connection feature on the platform 316A. The antenna 320A can be connected to the conductive material, such as by connecting the antenna 320A to the connector 322 so as to connect the antenna 320 to the television 302. The connector 322 can be an F-type or other antenna connector.

The antenna mount of FIG. 3A can provide forward and backward mobility for the platform 316A, such that the platform 316A can be situated in various locations relative to the back panel 304 of the television 302 (e.g., mobility in the y-direction). The antenna mount of FIG. 3A can provide side-to-side mobility for the platform 316A, such that the platform 316A can be situated in various locations relative to a side 324 of the television 302 (e.g., mobility in the x-direction). The antenna mount of FIG. 3A can provide vertical mobility for the platform 316A, such that the platform 316A can be situated in various locations relative to a top surface 308 of the television 302 (e.g., mobility in the z-direction).

FIG. 3B illustrates a perspective view diagram of an antenna mount system 300B according to another example. The system 300B includes an antenna mount attached to a back panel 304 of a television 302. The antenna mount can include post(s) 312C and/or 312B, a bracket 314B, an intermediate platform 322A, another bracket 324A, and the platform 316B.

The antenna mount is shown attached to a back panel 304 of the television 302. The posts 312C-D can be attached to the mounting holes of the back panel 304, such as by machine screws. The bracket 314B can be attached to the posts 312C-D, such as by machine screws, nuts, a slotted hole, a combination thereof, or other attachment mechanism. In one or more examples, the platform 322A can be attached to the bracket 314B, such as by machine screws, nuts, a combination thereof, or other attachment mechanism. In one or more other examples, the platform 322A can be integrally formed with the bracket 314A.

The bracket 324A can be attached to the platform 322A and the platform 316A, such as by machine screws, nuts, a combination thereof, or other attachment mechanism. In one or more examples, the platform 316A can be integrally formed with the bracket 324A. The antenna mount of FIG. 3B can provide forward and backward mobility for the platform 316B, such that the platform 316B can be situated in various locations relative to the front panel of the television 302 (e.g., mobility in the y-direction). The antenna mount of FIG. 3B can provide side-to-side mobility for the platform 316B, such that the platform 316B can be situated in various locations relative to a side 326 of the television 302 (e.g., mobility in the x-direction). The antenna mount of FIG. 3B can provide vertical mobility for the platform 316B, such that the platform 316B can be situated in various locations relative to a top surface 308 of the television 302 (e.g., mobility in the z-direction). The antenna mount of FIG. 3B can help keep the mount close to the back panel of a television with a non-flat back panel, such as a back panel as shown in FIG. 3B.

FIG. 3C illustrates a perspective view diagram of an antenna mount system 300C according to another example. The system 300C includes an antenna mount attached to a television stand 326. The antenna mount can include one or more brackets 314C, an intermediate platform 322B integrally formed with one of the brackets 314C, another bracket 324B, and another intermediate platform 328A integrally formed with the bracket 324B. The platform 316C can be attached to the platform 328A and an antenna 320C can be situated on the platform 316C.

The bracket 314C can be attached to the television stand 326, such as by machine screws, nuts, a slotted hole, a combination thereof, or other attachment mechanism. In one or more examples in which the platform 322B is not integrally formed with the bracket 314C, the platform 322B can be attached to the bracket 314C, such as by machine screws, nuts, a combination thereof, or other attachment mechanism.

The bracket 324B can be attached to the platform 322B, such as by machine screws, nuts, or a combination thereof. The antenna mount of FIG. 3C can provide forward and backward mobility for the platform 316C, such that the platform 316C can be situated in various locations relative to the back panel 304 of the television 302 (e.g., mobility in the y-direction). The antenna mount of FIG. 3C can provide side-to-side mobility for the platform 316C, such that the platform 316C can be situated in various locations relative to a side 324 of the television 302 (e.g., mobility in the x-direction). The antenna mount system 300C can help keep the antenna mount close to the back panel of a television with a non-flat back panel, such as a back panel as shown in FIG. 3C.

FIG. 3D illustrates a perspective view diagram of another antenna mount system 300D according to another example. The system 300D includes an antenna mount attached to a back panel 304 of a television 302. The antenna mount as illustrated includes one or more brackets 314D and an intermediate platform 322C integrally formed with one or more of the brackets 314D. The bracket 314D can be attached to the television back panel 304, such as by machine screws, or other attachment mechanisms. In one or more examples in which the platform 322C is not integrally formed with the bracket 314D, the platform 322C can be attached to the bracket 314D, such as by machine screws, nuts, a combination thereof, or other attachment mechanism. The platform 316D can be attached to the intermediate platform 322C, such as by machine screws, nuts, a combination thereof, or other attachment mechanism.

The antenna mount of FIG. 3D can provide forward and backward mobility for the platform 316D, such that the platform 316D can be situated in various locations relative to the back panel 304 of the television 302 (e.g., mobility in the y-direction). The antenna mount of FIG. 3D can provide side-to-side mobility for the platform 316D, such that the platform 316D can be situated in various locations relative to a side 324 of the television 302 (e.g., mobility in the x-direction). The antenna mount of FIG. 3D can provide vertical mobility for the platform 316D, such that the platform 316D can be situated in various locations relative to a top surface 308 of the television 302 (e.g., mobility in the z-direction). The antenna mount of FIG. 3D can help keep the antenna mount close to the back panel of a television with a non-flat back panel, such as a back panel as shown in FIG. 3D.

FIG. 3E illustrates a perspective view diagram of an antenna mount system 300E according to another example. The system 300E includes an antenna mount attached to a back panel 304 of a television 302. The antenna mount can include a channel bracket 330 (further illustrated in FIG. 3F) mounted between the antenna mount and the television 302. The antenna mount as illustrated include a bracket 314B, an intermediate platform 322A, another bracket 324A, and the platform 316B.

The antenna mount is shown attached to a back panel 304 of the television 302. The channel bracket 330 can be attached to the mounting holes of the back panel 304, such as by machine screws through the holes 342. The bracket 314B can be attached to the channel bracket 330, such as by machine screws, nuts, a slotted hole, a combination thereof, or other attachment mechanism. In one or more examples, the platform 322A can be attached to the bracket 314B, such as by machine screws, nuts, a combination thereof, or other attachment mechanism. In one or more other examples, the platform 322A can be integrally formed with the bracket 314A.

The bracket 324A can be attached to the platform 322A and the platform 316A, such as by machine screws, nuts, a combination thereof, or other attachment mechanism. In one or more examples, the platform 316A can be integrally formed with the bracket 324A. The antenna mount of FIG. 3B can provide forward and backward mobility for the platform 316B, such that the platform 316B can be situated in various locations relative to the front panel of the television 302 (e.g., mobility in the y-direction). The antenna mount of FIG. 3B can provide side-to-side mobility for the platform 316B, such that the platform 316B can be situated in various locations relative to a side 324 of the television 302 (e.g., mobility in the x-direction). The antenna mount of FIG. 3B can provide vertical mobility for the platform 316B, such that the platform 316B can be situated in various locations relative to a top surface 308 of the television 302 (e.g., mobility in the z-direction). The antenna mount of FIG. 3B can help keep the mount close to the back panel of a television with a non-flat back panel, such as a back panel as shown in FIG. 3B.

The antenna 320E depicted in FIG. 3E is built directly into the platform 316B. The platform 316B can include a mechanism, such as a motor or a manual turning mechanism mechanically coupled thereto to allow a user to rotate and/or tune the antenna 320E.

An example of the channel bracket 330 is illustrated in FIG. 3F. The channel bracket 330 includes a recessed portion through which one or more television cables (e.g., a coaxial cable, a Universal Serial Bus (USB) cable, a power cable, RF cable, High Definition Multimedia Interface (HDMI) cable, an audio visual (A/V) cable, a Sony Phillips Digital Interface Format (S/PDIF) cable, among other television cables) can be routed. The channel bracket 330 can include holes 342 configured to match a mount hole configuration on the back of the television 302, such that a machine screw can be inserted through the hole 342 and screwed into a mount hole on the television. The channel bracket 330 can include holes 344 to which the antenna mount can be mounted. The channel bracket 330 can provide a convenient location to hide television cables. FIG. 3G illustrates a perspective view diagram of a channel cover 340 according to an example. The channel cover 340 is configured to connect to the channel bracket 330 and cover the recessed portion of the channel bracket 330 of FIG. 3F.

The platform 316B of FIG. 3E includes a pocket 332 attached thereto. The pocket 332 can provide a location to store one or more items such as a remote control, mobile phone, headphones, or other item.

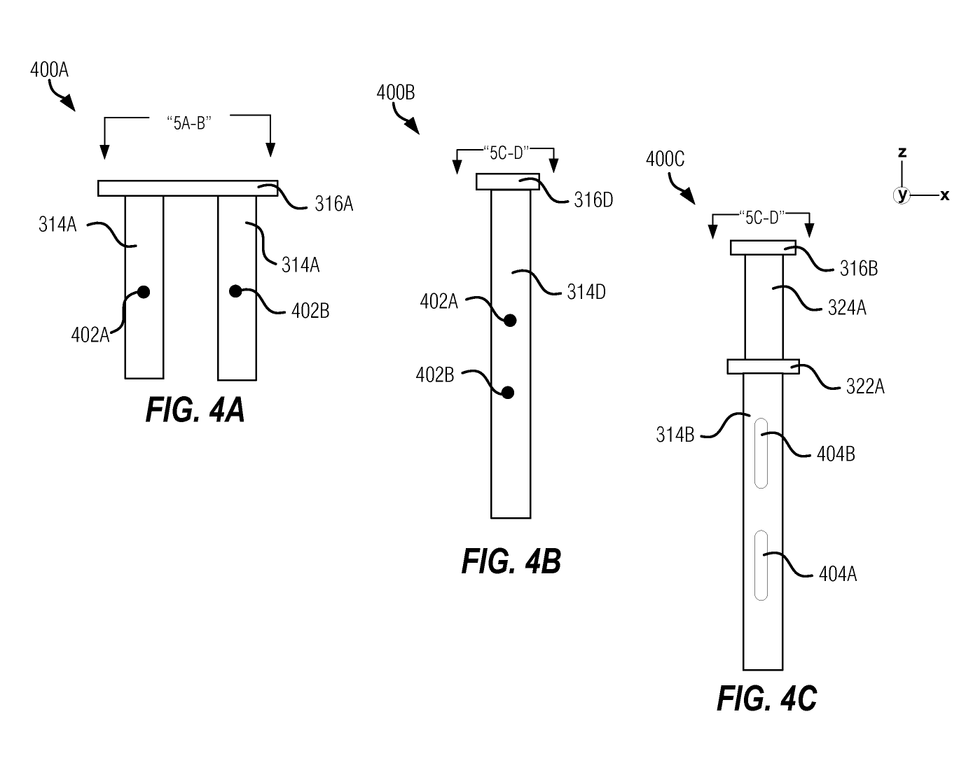

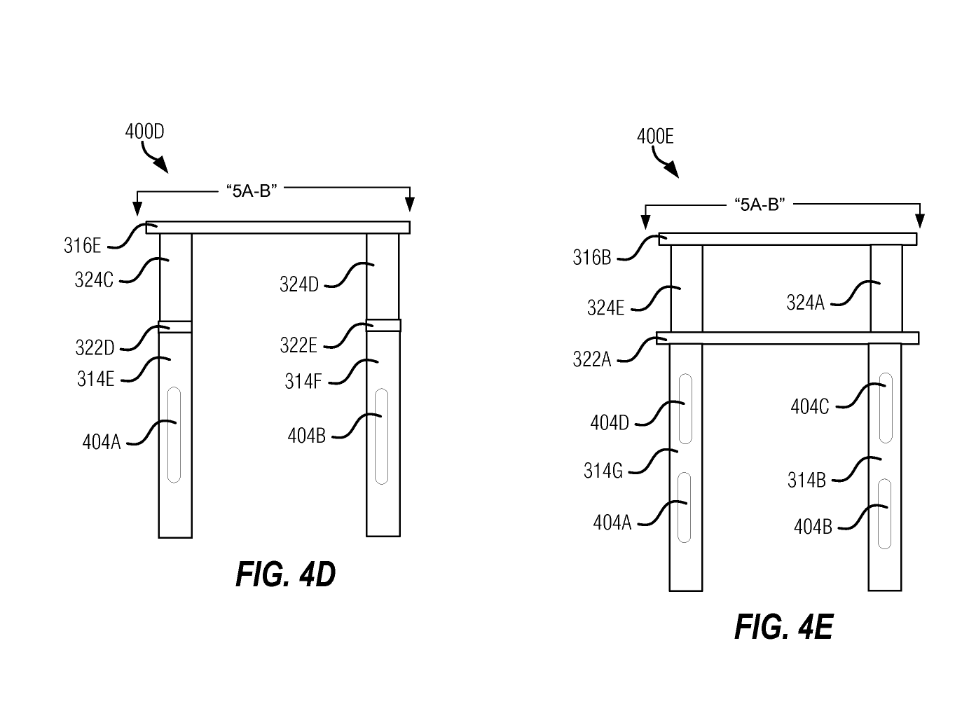

FIG. 4A illustrates a perspective view diagram of an antenna mount 400A according to an example, such as the antenna mount of FIG. 3A as viewed from the arrows labelled “4A”. The antenna mount 400A as illustrated includes two brackets 314A connected to (e.g., integrally formed with or attached to) the platform 316A. The brackets 314A each include a hole 402A and 402B (e.g., a threaded or unthreaded hole configured to allow a machine screw therethrough), respectively. The bracket 314A can be mounted to the mounting holes 202A-D of the television 302 through the screw holes 402A-B. Alternatively, instead of a screw hole 402A-B, the brackets 314A can include one or more slots, see FIGS. 4C, 4D, and 4E for example. The slots can provide variability in positioning the brackets 314A and the antenna mount platform 316A in a vertical location relative to the top surface of the television 302 (e.g., can provide mobility in the z-direction).

FIG. 4B illustrates a perspective view diagram of an antenna mount 400B according to another example, such as the antenna mount of FIG. 3D as viewed from the arrows labelled “4B”. The antenna mount 400B as illustrated includes one bracket 314D connected to (e.g., integrally formed with or attached to) the platform 316D. The bracket 314D includes two screw holes 402A and 402B, respectively, for mounting to the mounting holes of the television 302. Alternatively, instead of a screw hole 402A-B, the bracket 314D can include one or more slots, see FIGS. 4C, 4D, and 4E for example. The slots can provide variability in positioning the bracket 314D and the antenna mount platform 316D in a vertical location relative to the top surface of the television 302. Also, the slots can accommodate variability in the vertical distance between mounting holes (see 206A-B of FIG. 2).

FIG. 4C illustrates a perspective view diagram of another antenna mount 400C according to an example, such as the antenna mount of FIG. 3B as viewed from the arrows labelled “4C/E”. The antenna mount 400C as illustrated includes a bracket 314B with two slots 404A and 404B therein. The slots 404A-B can provide variability in positioning the bracket 314B (and the antenna mount platform 316B) in a vertical location relative to the top surface of the television (e.g., mobility in the z-direction). Also, the slots 404A-B can accommodate variability in the vertical distance between mounting holes (see 206A-B of FIG. 2). Having at least two connection points on a single bracket can help prevent rotational motion of the bracket after the bracket is mounted.

FIG. 4D illustrates a perspective view diagram of another antenna mount 400D according to an example. The antenna mount 400D as illustrated includes two brackets 314E and 314F each including a single slot 404A and 404B, respectively. Using two brackets 314E and 314F can help prevent rotational motion of the platform 316E. The brackets 314E and 314F can each be attached to (or integrally formed with) the intermediate platforms 322D and 322E, respectively. The brackets 324C and 324D can be attached to the platforms 322D and 322E, respectively. The platform 316E can be attached to both the brackets 324C and 324D. “Attaching items” as used herein includes attaching items at mating connection features.

FIG. 4E illustrates a perspective view diagram of an antenna mount 400E according to an example, such as the antenna mount of FIG. 3B as viewed from the arrows labelled “4C/E”. The antenna mount 400E as illustrated includes two brackets 314G and 314B each including two slots 404A and 404D and 404B and 404C, respectively. Using two brackets with two mounting slots can help increase the load capacity of the platform 316B, such as can allow for more weight to be placed on the platform 316B safely. The brackets 314G and 314B can each be attached to (or integrally formed with) the intermediate platform 322A. The brackets 324E and 324A can be attached to the platform 322A. The platform 316B can be attached to (or integrally formed with) both the brackets 324E and 324F.

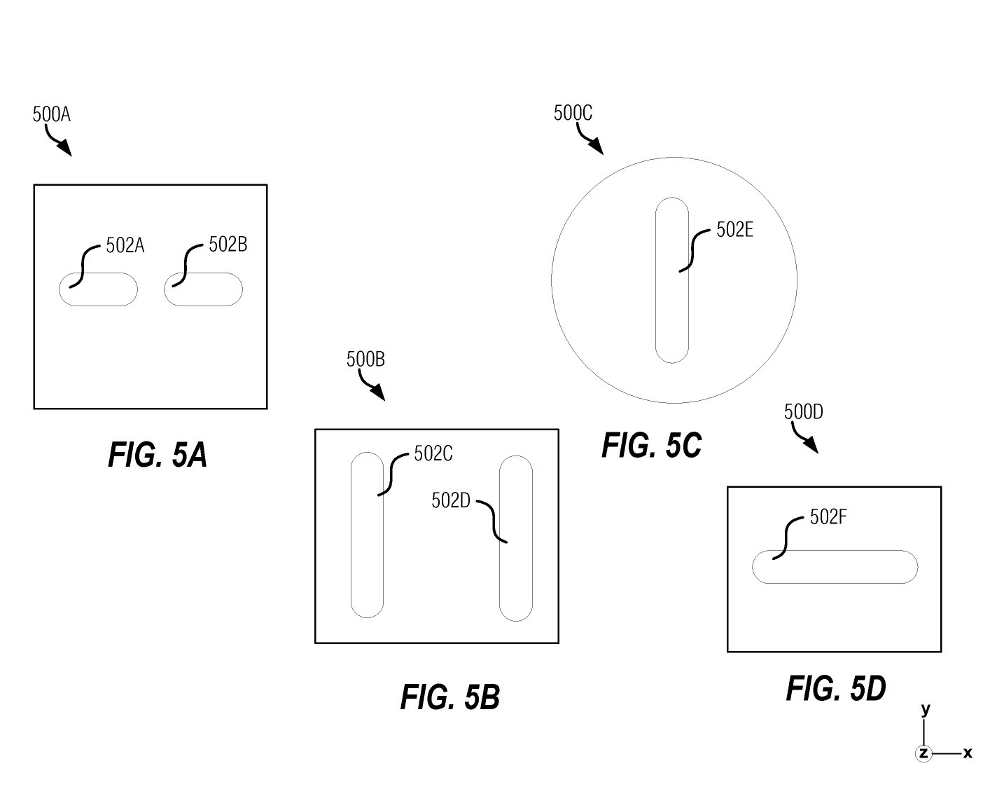

FIGS. 5A-5D illustrate perspective view diagrams of examples of platforms 500A, 500B, 500C, and 500D, respectively, according to an example. In one or more examples, FIGS. 5A-5D show perspective diagrams of the platforms 316A-D and 322A-E as viewed from the arrows labelled “5A-B” or “5C-D”. The platform 500A as illustrated includes two slots 502A and 502B therein. The slots 502A-B are configured to attach to the brackets of the antenna mount. The slots 502A-B are sized and shaped to allow the threaded portion of a screw therethrough while stopping the head of the screw from going through the slot 502A-B. The slots 502A-B are oriented so as to provide a variety of attachment points for the brackets. The slots 502A-B provide side-to-side mobility for the platform 500A, such that the platform 500A can be situated at a range of locations along the x-direction.

The platform 500B as illustrated includes two slots 502C and 502D therein. The slots 502C-D are configured to attach to the brackets of an antenna mount. The slots 502C-D are sized and shaped to allow the threaded portion of a screw therethrough while stopping the head of the screw from going through the slot. The slots 502C-D are oriented so as to provide a variety of attachment points for the brackets. The slots 502C-D provide front-to-back mobility for the platform 500A, such that the platform 500A can be situated at a variety of locations along the y-direction.

The platform 500C of FIG. 5C is similar to the platform 500A of FIG. 5A with the platform 500C including a single slot 502E and an elliptical shape instead of a rectangular shape. The platform 500D of FIG. 5D is similar to the platform 500A with the platform 500D including a single slot 502F.

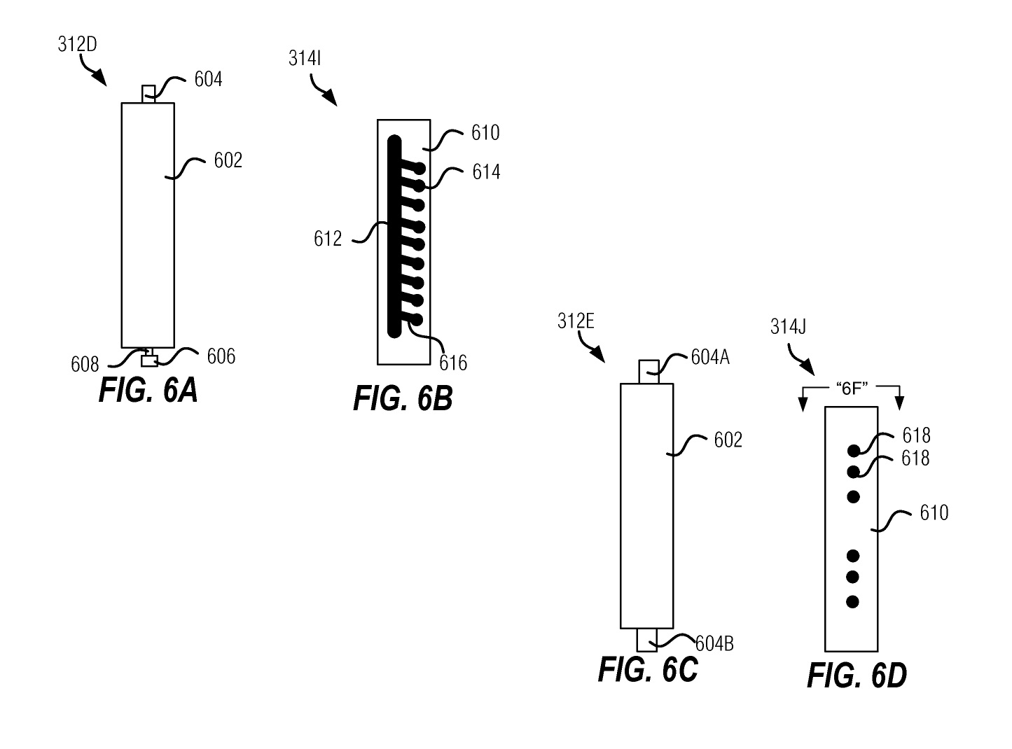

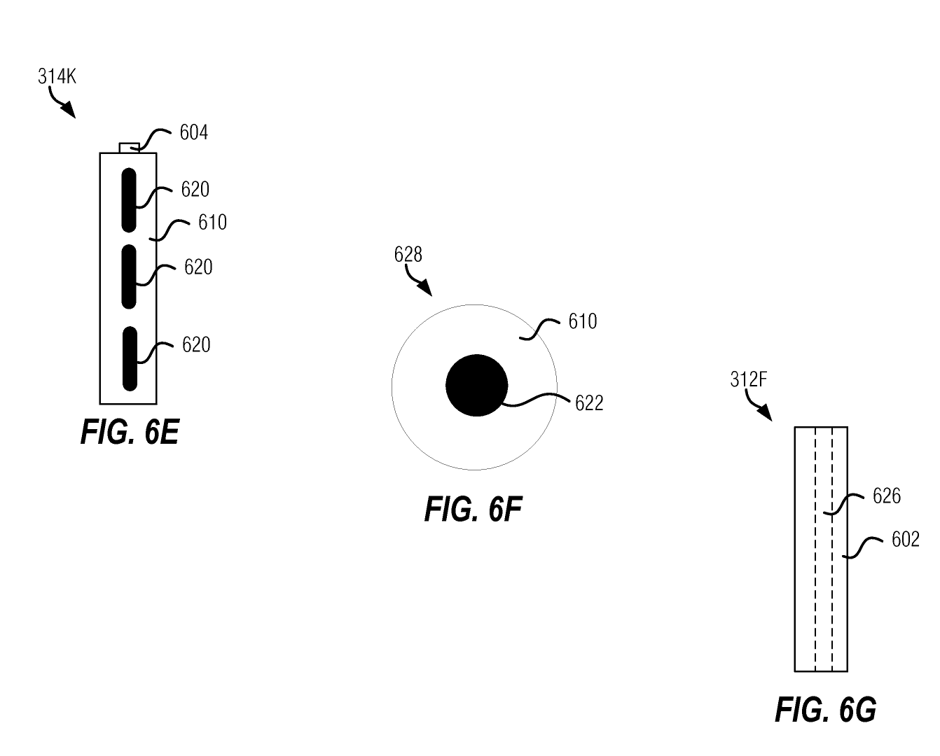

FIG. 6A illustrates a perspective view diagram of a post 312D configured for mounting to a back panel of a television according to an example. Any of the posts 312A-C can be configured like the post 312D. The post 312D as illustrated includes a body 602 with a machine screw 604 attached at a first end thereof. The post 312D as illustrated includes a thinner column 608 attached to a thicker column 606 at a second end thereof. The machine screw 604 is configured to attach to a mounting hole 202A-D. The attachment mechanism on the other end of the post 312 that comprises the thinner column 608 and the thicker column 606 is configured to attach to the bracket 3141 as shown in FIG. 6B.

FIG. 6B illustrates a perspective view diagram of a bracket 3141 configured to mount on the post 312D of FIG. 6A according to an example. Any of the brackets 314A, 314B, and 314D can be configured like the bracket 3141. The bracket 3141 as illustrated includes a body 610 with a slot 612 therein. The bracket 3141 includes channels 616 each connecting a hole 614 to the slot 612. The slot 612 include a width greater than then a width of the thicker column 606 so as to permit the thicker column 606 to penetrate the slot 612. The channel 616 includes a width greater than the thinner column 608 and less than the thicker column 606 so as to permit the thinner column 608 to slide through the channel 616 and rest in the hole 614. Since the body 602 of the post 312 and the thicker column 606 are wider than the hole 614, the post 312 can be secured to the bracket 3141. The body 610 can be rectangular, elliptical, polygonal, or an irregular shape in a cross-section thereof.

FIG. 6C illustrates a perspective view diagram of another post 312E for mounting to a back panel of a television according to an example. Any of the posts 312A-C can be configured like the post 312E. The post 312E as illustrated includes a body 602 with machine screws 604A and 604B attached to both ends thereof. One of the machine screws 604A is configured to attach to a mounting hole 202A-D. The other machine screw 604B on the other end of the post 312E is configured to attach to the bracket 314A-H or 314J-K.

FIG. 6D illustrates a perspective view diagram of a bracket 314J configured to mount on the post 312E of FIG. 6C according to an example. Any of the brackets 314A, 314B, and 314D can be configured like the bracket 314J. The bracket 314J as illustrated includes a body 610 with holes 618 that provide a variety of mounting locations for the post 312. The machine screw 604B can be slotted into any of the holes 618 and a nut can be screwed onto the machine screw 604B to secure the bracket 314J to the post 312E. While 6D illustrates the bracket 314J as including six holes, the bracket 314J can include one or more holes therein.

FIG. 6E illustrates a perspective view diagram of an example of a bracket 314K configured to mount on the post 312E of FIG. 6C according to an example. Any of the brackets 314A, 314B, and 314D can be configured like the bracket 3141. The bracket 314K as illustrated includes a body 610 with slots 620 that provide a variety of mounting locations for the post 312E therein. The machine screw 604 can be slotted into any of the slots 620 and a nut can be screwed onto the machine screw 604 to secure the bracket 314K to the post 312E. While 6D illustrates the bracket 314K as including three slots, the bracket 314K can include one or more slots 620 therein. The slot 620 provides a range of locations the platform 316 can be situated in the z-direction. The bracket 314K can include a machine screw 604 attached to end thereof. The machine screw 604 can help attached the bracket to an intermediate platform 324A-E or a platform 316A-D.

FIG. 6F illustrates a perspective view diagram of a structure 628, such as a bracket or post as viewed from the arrows labelled “6F” according to an example. The structure 628 as illustrated includes a hole 622 (e.g., a threaded hole (a mounting hole) or an unthreaded hole) in the body 610. The hole 622 can be threaded to allow a machine screw or other threaded screw to be screwed therein. The machine screw can secure the platform 316A-D or the intermediate platform 322A-D to a bracket 314A-K or 324A-E.

FIG. 6G illustrates a perspective view diagram of a post 312F (e.g., a spacer) configured for mounting to a back panel of a television according to an example. The post 312F as illustrated includes a body 602 with a hole 626 therethrough. The hole 626 is configured to allow a threaded portion of a machine screw therethrough, so as to allow the machine screw to be screwed into a mounting hole on the television.

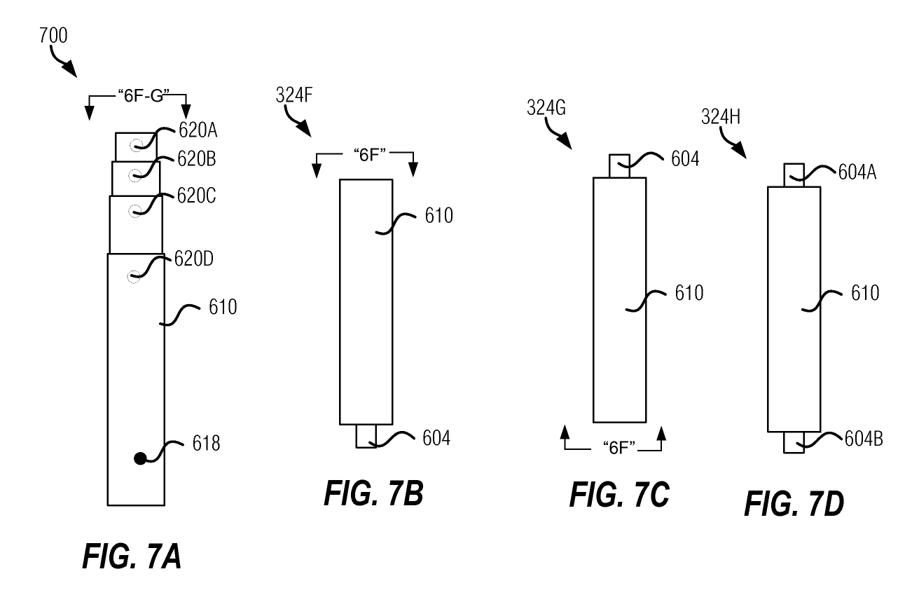

FIG. 7A illustrates a perspective view diagram of a telescoping bracket 700 according to an example. The bracket 700 can be mounted to a post 312A-F, the platform 322A-E, the platform 316A-D, or directly to the mounting holes of the television. The bracket 700 is extensible, such as by rotating a portion of the bracket 700L. The telescoping bracket 700 can provide a variety of positions for the platform 316A-B or 324A-D in the z-direction. Any of the brackets 314A-H, 314J-K, or 324F-H can be telescoping as shown in FIG. 7A. The bracket 700 includes a plurality of locking mechanisms 620A, 620B, 620C, and 620D configured to lock the telescoping bracket 700 in place and provide a force resistant to the telescoping bracket collapsing.

FIG. 7B illustrates a perspective view diagram of a bracket 324F according to an example. The bracket 324F can be mounted on the platform 322A-D. The bracket 324F can be telescoping, such as to provide for a range of lengths for the bracket 324F in the z-direction. The bracket 324F includes a machine screw attached to first end thereof and a mounting hole in a second end thereof. The machine screw 604 is configured to allow the bracket to be attached to an intermediate platform 322A-D or the platform 316A-D such as by screwing a nut onto machine screw 604. The mounting hole provides a location for a machine screw to be screwed through a slot or hole in the platform 316A-D and attach the bracket 324F to the platform 316A-D.

FIG. 7C illustrates a perspective view diagram of a bracket 324G according to an example. The bracket 324G can be mounted on the platform 322A-D. The bracket 324G can be telescoping, such as to provide for a range of lengths for the bracket 324G in the z-direction. The bracket 324G includes a machine screw attached to first end thereof and a mounting hole in a second end thereof. The machine screw 604 is configured to allow the bracket to be attached to the platform 316A-D such as by screwing a nut onto machine screw 604. The mounting hole provides a location for a machine screw to be screwed through a slot or hole in the platform 322A-D and attach the bracket 324G to the platform 322A-D.

FIG. 7D illustrates a perspective view diagram of a bracket 324H according to an example. The bracket 324H can be mounted on the platform 322A-D. The bracket 324H can be telescoping, such as to provide for a range of lengths for the bracket 324G in the z-direction. The bracket 324H includes a machine screw attached to first end thereof and another machine screw attached to a second end thereof. The machine screw 604A is configured to allow the bracket 324H to be attached to the platform 316A-D such as by screwing a nut onto machine screw 604A. The machine screw 604B is configured to allow the bracket 324H to be attached to the platform 322A-D, such as by screwing a nut onto the other machine screw 604B.

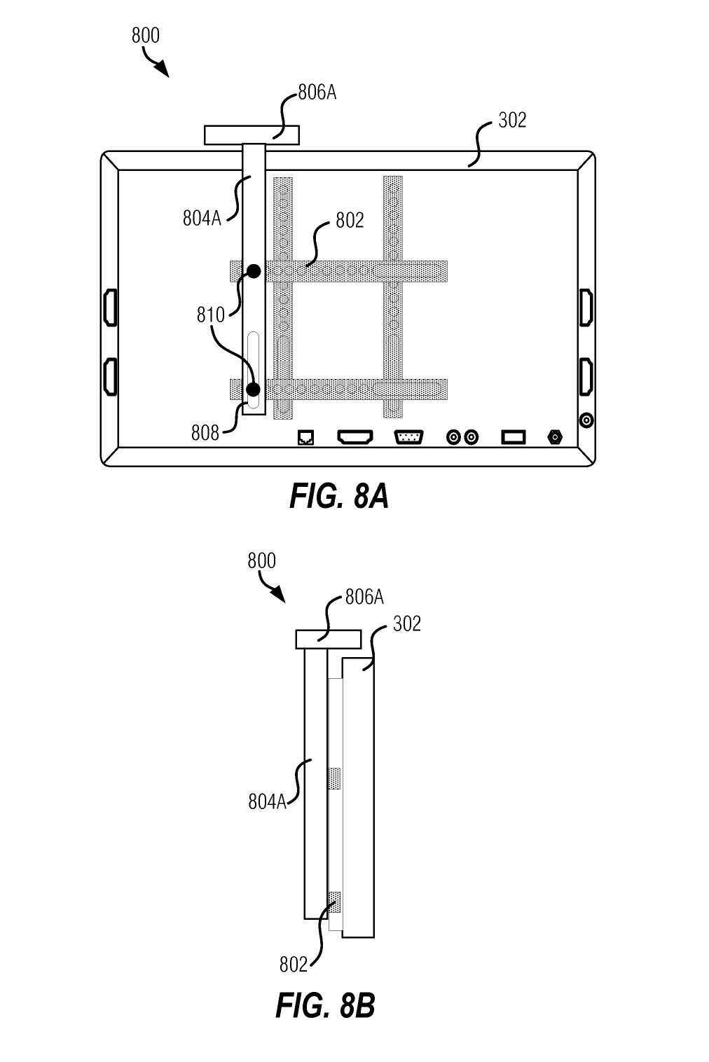

FIG. 8A illustrates a perspective view diagram of an antenna mount system 800 including an antenna mount attached to a wall mount 802 on a back panel of a television 302 according to an example. The antenna mount includes a single bracket 804A attached to the wall mount 802 in two locations. The first location includes a hole in the bracket 804A with a machine screw 810 through the bracket 804A and screwed into a hole in the wall mount 802. The second location includes a slot 808 in the bracket 804A and a machine screw 810 through the slot 808 and screwed into another hole in the wall mount 802. By including the slot 808, the bracket 804A can accommodate a variety of wall mount bracket spacings.

FIG. 8B illustrates a side view diagram of the antenna mount system 800 of FIG. 8A according to an example. The hole in the bracket 804A can be a slot, such as to allow the bracket 804A to accommodate more wall mounts or the slot 808 can be a hole, such as to provide more mechanical stability to the bracket mounting. The platform 806A can be attached to the bracket 804A, such by one or more screws, bolts, or nuts, or the platform 806A can be integrally formed with the bracket 804A. The platform 806A can be configured the same as the platform 316A-B. The bracket 804A can be configured the same as the bracket 314A-K in other examples.

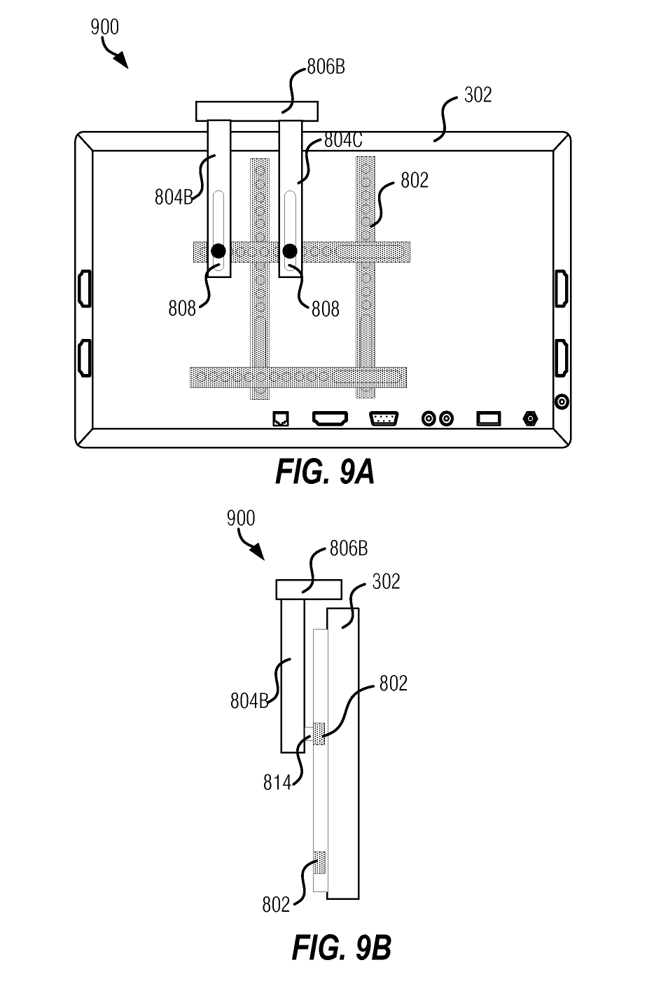

FIG. 9A illustrates a perspective view diagram of another antenna mount system 900 including an antenna mount attached to a wall mount 802 on a back panel of a television 302 according to an example. The antenna mount includes two brackets 804B and 804C attached to the wall mount 802 by machine screws. The brackets 804B-C each include a slot 808 therein, through which the respective bracket 804B-C is screwed to the wall mount 802. The bracket 804B-C can be attached to the platform 806B, such as by one or more machine screws or nuts or can be integrally formed with the platform 806B.

FIG. 9B illustrates a side view diagram of the antenna mount system 900 of FIG. 9A according to an example. The system 900 as illustrated in FIG. 9B includes a spacer 814 between the antenna mount and the wall mount 802. The spacer 814 can be configured the same as any of the posts discussed herein. The platform 806B can be configured the same as the platform 316A-B. In other examples, the bracket 804B-C can be configured the same as the bracket 314A-K.

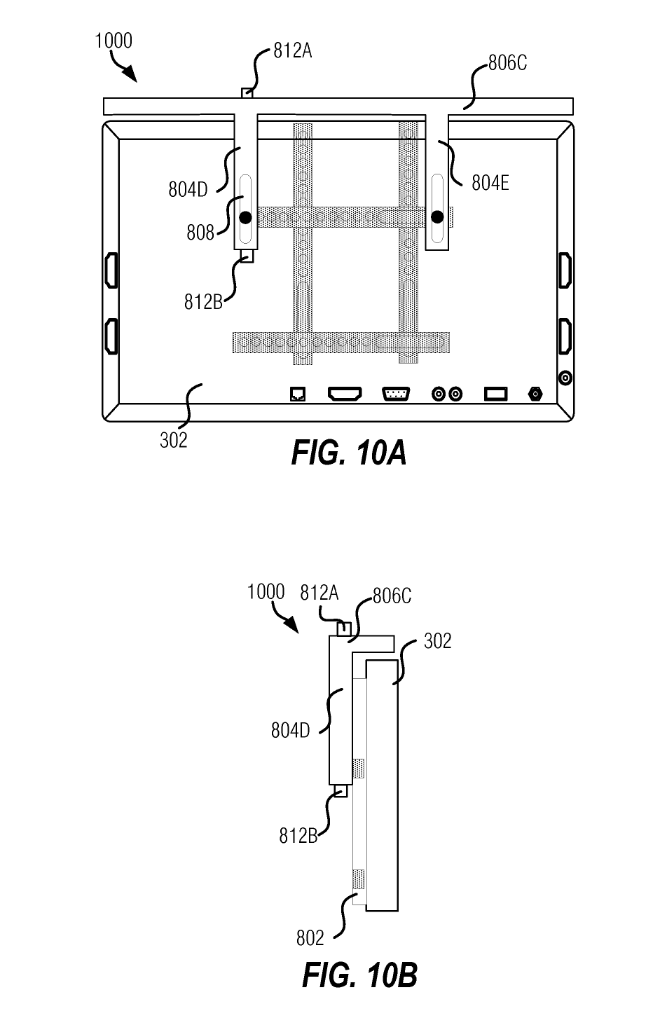

FIG. 10A illustrates a perspective view diagram of another antenna mount system 1000 including an antenna mount attached to a wall mount 802 on a back panel of a television 302 according to an example. The antenna mount includes two brackets 804D and 804E attached to the wall mount 802 by machine screws. The brackets 804D-E each include a slot 808 therein, through which the respective bracket 804D-E is screwed to the wall mount 802. The bracket 804D-E can be attached to the platform 806C, such as by one or more machine screws or nuts or can be integrally formed with the platform 806B. The platform 806C can include a connector 812A thereon. The connector 812A can be electrically coupled to another connector 812B on the bracket 804D. The connector 812 can help reduce the amount of cable required to attach an antenna on the platform 806C to the television. FIG. 8F illustrates, by way of example, a side view diagram of the antenna mount system 800B of FIG. 8C. The platform 806C can be configured the same as the platform 316A-B. The bracket 804D-E can be configured the same as the bracket 314A-K.

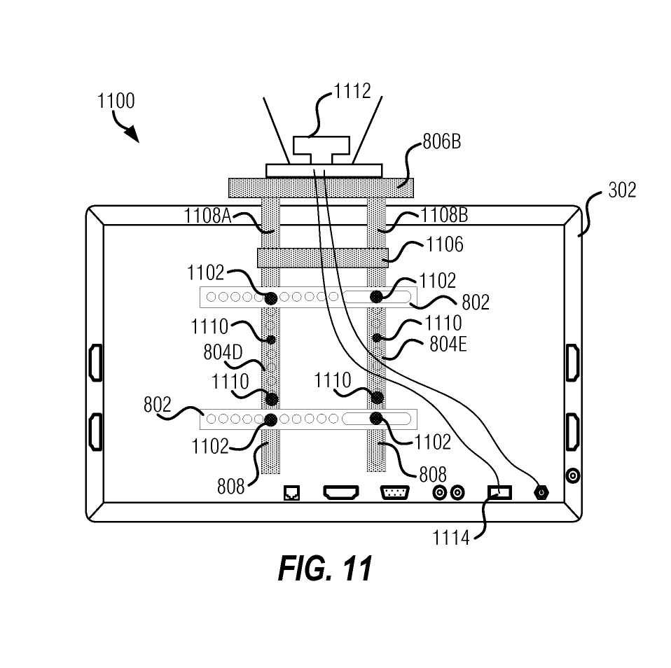

FIG. 11 illustrates a perspective view diagram of a wall mount bracket attached to an antenna mount that is attached to a back panel of a television according to an example. The antenna mount includes brackets 804D and 804E attached to the television 302 by machine screws 1110. The brackets 804D-E each include a slot 808 therein, through which the respective bracket 804D-E is screwed to the television 302.

The bracket 804D-E can be attached to the platform 1106, such as by one or more machine screws or nuts or can be integrally formed with the platform 1106. Brackets 1108A and 1108B can be mounted to the platform 1106 and to the platform 806B. The television wall mount 802 can be attached to the antenna mount by the screws 1102. An antenna 1112 can be situated on the platform 806B. The antenna 1112 depicted is an active antenna. The antenna 1112 can be powered over USB using a USB output port 1114 of the television 302.

The platforms discussed herein can be used to provide a convenient location for an antenna or other television equipment, such as a digital video recorder, digital video disc (DVD) or Blu-ray player, or similar, a sensor, a speaker, or other television equipment. As will be understood, the use of the described platforms may be restricted to provide adequate support and safety of any objects that are placed upon the platform.

In one or more embodiments, an antenna can be built into the platform. The antenna can be a variety of antennas, such as an active antenna, a loop antenna, a flat antenna, a digital signal antenna, a UHF or VHF antenna, or other antenna. As used herein a “connection feature” includes a means by or through which an item (e.g., a platform, post, bracket, brace, or the like) can be connected to another item. The connection feature can include a hole (e.g., a slot) through which a bolt can be passed, a screw, a tabbed locking device, or other connection feature. Mating connection features can be connected to each other. For example, a male tabbed locking device can be connected to a mating tabbed locking device. In another example, a screw can be passed through a mating hole to allow the screw to be screwed into a screw hole or a nut to secure the screw to the item with the hole. In yet another example, a hole can be in line with another hole so that a screw or other locking mechanism can pass through both holes to secure the items with the holes to each other.

Additional examples of the presently described subject matter examples include the following, non-limiting configurations. Each of the following non-limiting examples may stand on its own, or may be combined in any permutation or combination with any one or more of the other examples provided below or throughout the present disclosure. The following examples are provided with reference to specific antenna mount configurations, but it will be understood that in some examples, the claimed structures may be embodied by other apparatuses and devices.

A first configuration, Example 1, includes subject matter embodied by an antenna mount configured for mounting with a television, the antenna mount comprising: a first post that receives a first connector to mount the first post in a first mounting hole located in a back panel of the television; a first brace that includes a first connection feature to attach to a first mating connection feature of the first post; and a platform that provides a surface on which to receive an antenna, wherein the platform is secured to the first brace with a first attachment mechanism; wherein the first brace provides a length sufficient to allow the platform to be positioned above a top edge of the television in the mounting with the television.

In Example 2, the subject matter of Example 1 may include, wherein the first post receives a second connector to mount the first post in a second mounting hole located in the back panel of the television, wherein a position of the first mounting hole and the second mounting hole and wherein a shape of the first connector and the second connector conform to a Video Electronics Standards Association (VESA) specification.

In Example 3, the subject matter of any one of Examples 1 to 2 may include, a second post that receives a second connector to mount the second post in a second mounting hole located in the back panel of the television; and a second brace that includes a second connection feature to attach to a second mating connection feature of the second post; wherein the platform is further secured to the second brace with a second attachment mechanism.

In Example 4, the subject matter of any one of Examples 1 to 3 may include, wherein the first attachment mechanism is configured to receive a fastener within a first slot, the first slot to provide a variable attachment location of the platform relative to the first brace and to allow the platform to be rotated relative to the first attachment mechanism.

In Example 5, the subject matter of any one of Examples 1 to 4 may include, wherein the first connection feature of the first brace includes a connector to extend through one of a plurality of holes, and wherein the first mating connection feature of the first post includes a second connector on an end of the first post opposite the first connector.

In Example 6, the subject matter of any one of Examples 1 to 5 may include, wherein the first brace includes a telescoping member to allow extension of an end of the first brace, the end of the first brace attached to the platform.

In Example 7, the subject matter of any one of Examples 1 to 6 may include, wherein the first brace includes a channel running longitudinally therethrough.

In Example 8, the subject matter of any one of Examples 1 to 7 may include, an electrically conductive element in the channel; and a male coax connector positioned on a first end of the first brace, the first end of the first brace being opposite a second end of the first brace that attaches to the platform, the male coax connector being electrically connected to the electrically conductive element.

In Example 9, the subject matter of Example 8 may include, a female coax connector positioned on the platform, the female coax connector being electrically connected to the electrically conductive element.

In Example 10, the subject matter of any one of Examples 1 to 9 may include, wherein the first post is shaped to receive a machine screw compatible with a Video Electronics Standards Association (VESA) specification-compliant mounting hole.

In Example 11, the subject matter of any one of Examples 1 to 10 may include, a second post that receives a second connector to mount the second post in a second mounting hole located in the back panel of the television, wherein the first brace includes a second connection feature to attach to a second mating connection feature of the second post.

A second configuration, Example 12 includes subject matter embodied by an antenna mount configured for mounting with a back panel of a television, the antenna mount comprising: a first vertical brace that includes one or more holes therethrough, the one or more holes located so as to provide multiple locations to mount the first vertical brace to a first mounting hole on the back panel of the television in an orientation that is substantially parallel to the back panel of the television; an intermediate horizontal platform that includes a first connection feature to mount the intermediate horizontal platform to the first vertical brace, the intermediate horizontal platform structured so as to be positioned in an orientation that is substantially perpendicular to the back panel of the television; a second vertical brace that includes a second connection feature to attach the second vertical brace to a mating connection feature of the intermediate platform; and a shelf platform that provides a surface on which to support an antenna thereon, the shelf platform including a third connection feature to connect the shelf platform to a mating connection feature of the second vertical brace.

In Example 13, the subject matter of Example 12 may include, wherein the one or more holes of the first vertical brace are provided from at least one slot.

In Example 14, the subject matter of any one of Examples 12 to 13 may include, wherein the first connection feature includes a slot in the intermediate horizontal platform to receive a fastener, and wherein the third connection feature includes a slot in the shelf platform to receive a fastener, the slot in the shelf platform arranged to be generally perpendicular to the slot in in the intermediate horizontal platform.

In Example 15, the subject matter of any one of Examples 12 to 14 may include, a first post that receives a first machine screw to mount the first post in the first mounting hole in the back panel of the television via the first vertical brace.

A third configuration, Example 16 includes subject matter embodied by a platform mount for coupling with a television wall mount, the platform mount comprising: a brace that includes a hole therein to receive a machine screw to mount to a television, the machine screw to extend between a television wall mount and a back panel of a television; and a platform that includes a connection feature to couple the platform to the brace, the platform including a surface on which to receive an object, wherein the brace extends beyond the back panel of the television to support the platform on a side of the television.

In Example 17, the subject matter of any one of Examples 16 may include, wherein the hole of the brace is provided by a slot to allow adjustable attachment of the brace relative to the television wall mount and the back panel of the television.

In Example 18, the subject matter of any one of Examples 16 to 17 may include, a second brace that includes a hole therein to receive a second machine screw to mount to the television, the second machine screw to extend between the television wall mount and the back panel of a television, wherein the platform includes a second connection feature to couple the platform to the second brace.

In Example 19, the subject matter of any one of Examples 16 to 18 may include, wherein the hole in the brace and the hole in the second brace are slots configured to allow the respective braces to be attached to the television wall mount at varying locations along the slots of the respective braces.

In Example 20, the subject matter of any one of Examples 16 to 19 may include, wherein the platform includes a slot therein configured to allow the brace to be attached to the platform at a variety of locations along the slot and to allow the platform to rotate about the slot.

The above detailed description includes references to the accompanying drawings, which form a part of the detailed description. The drawings show, by way of illustration, specific examples in which methods, apparatuses, and systems discussed herein can be practiced. These examples are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

1. An antenna mount configured for mounting with a television, the antenna mount comprising:
a first post that receives a first connector to mount the first post in a first mounting hole located in a back panel of the television;
a first brace that includes a first connection feature to attach to a first mating connection feature of the first post; and
a platform that provides a surface on which to receive an antenna, wherein the platform is secured to the first brace with a first attachment mechanism;
wherein the first brace provides a length sufficient to allow the platform to be positioned above a top edge of the television in the mounting with the television.

2. The antenna mount of claim 1, wherein the first post receives a second connector to mount the first post in a second mounting hole located in the back panel of the television, wherein a position of the first mounting hole and the second mounting hole and wherein a shape of the first connector and the second connector conform to a Video Electronics Standards Association (VESA) specification.

3. The antenna mount of claim 1, further comprising:
a second post that receives a second connector to mount the second post in a second mounting hole located in the back panel of the television; and
a second brace that includes a second connection feature to attach to a second mating connection feature of the second post;
wherein the platform is further secured to the second brace with a second attachment mechanism.

4. The antenna mount of claim 1, wherein the first attachment mechanism is configured to receive a fastener within a first slot, the first slot to provide a variable attachment location of the platform relative to the first brace and to allow the platform to be rotated relative to the first attachment mechanism.

5. The antenna mount of claim 1, wherein the first connection feature of the first brace includes a connector to extend through one of a plurality of holes, and wherein the first mating connection feature of the first post includes a second connector on an end of the first post opposite the first connector.

6. The antenna mount of claim 1, wherein the first brace includes a telescoping member to allow extension of an end of the first brace, the end of the first brace attached to the platform.

7. The antenna mount of claim 1, wherein the first brace includes a channel running longitudinally therethrough.

8. The antenna mount of claim 7, comprising:
an electrically conductive element in the channel; and
a male coax connector positioned on a first end of the first brace, the first end of the first brace being opposite a second end of the first brace that attaches to the platform, the male coax connector being electrically connected to the electrically conductive element.

9. The antenna mount of claim 8, comprising:
a female coax connector positioned on the platform, the female coax connector being electrically connected to the electrically conductive element.

10. The antenna mount of claim 1, wherein the first post is shaped to receive a machine screw compatible with a Video Electronics Standards Association (VESA) specification-compliant mounting hole.

11. The antenna mount of claim 1, comprising a second post that receives a second connector to mount the second post in a second mounting hole located in the back panel of the television, wherein the first brace includes a second connection feature to attach to a second mating connection feature of the second post.

12. An antenna mount configured for mounting with a back panel of a television, the antenna mount comprising:
a first vertical brace that includes one or more holes therethrough, the one or more holes located so as to provide multiple locations to mount the first vertical brace to a first mounting hole on the back panel of the television in an orientation that is substantially parallel to the back panel of the television;
an intermediate horizontal platform that includes a first connection feature to mount the intermediate horizontal platform to the first vertical brace, the intermediate horizontal platform structured so as to be positioned in an orientation that is substantially perpendicular to the back panel of the television:
a second vertical brace that includes a second connection feature to attach the second vertical brace to a mating connection feature of the intermediate platform; and
a shelf platform that provides a surface on which to support an antenna thereon, the shelf platform including a third connection feature to connect the shelf platform to a mating connection feature of the second vertical brace.

13. The antenna mount of claim 12, wherein the one or more holes of the first vertical brace are provided from at least one slot.

14. The antenna mount of claim 12, wherein the first connection feature includes a slot in the intermediate horizontal platform to receive a fastener, and wherein the third connection feature includes a slot in the shelf platform to receive a fastener, the slot in the shelf platform arranged to be generally perpendicular to the slot in in the intermediate horizontal platform.

15. The antenna mount of claim 12, comprising a first post that receives a first machine screw to mount the first post in the first mounting hole in the back panel of the television via the first vertical brace.

16. A platform mount for coupling with a television wall mount, the platform mount comprising:
a brace that includes a hole therein to receive a machine screw to mount to a television, the machine screw to extend between a television wall mount and a back panel of a television; and
a platform that includes a connection feature to couple the platform to the brace, the platform including a surface on which to receive an object, wherein the brace extends beyond the back panel of the television to support the platform on a side of the television.

17. The platform mount of claim 16, wherein the hole of the brace is provided by a slot to allow adjustable attachment of the brace relative to the television wall mount and the back panel of the television.

18. The platform mount of claim 16, comprising a second brace that includes a hole therein to receive a second machine screw to mount to the television, the second machine screw to extend between the television wall mount and the back panel of a television, wherein the platform includes a second connection feature to couple the platform to the second brace.

19. The platform mount of claim 18, wherein the hole in the brace and the hole in the second brace are slots configured to allow the respective braces to be attached to the television wall mount at varying locations along the slots of the respective braces.

20. The platform mount of claim 16, wherein the platform includes a slot therein configured to allow the brace to be attached to the platform at a variety of locations along the slot and to allow the platform to rotate about the slot.
